(19) United States
(12) Patent Application Publication
(10) Pub. No.: US 2012/0129419 A1
(43) Pub. Date: May 24, 2012

(54) DISPLAY-PANEL INSPECTION METHOD, AND METHOD FOR FABRICATING DISPLAY DEVICE

(76) Inventors: Naoki Yoshimoto, Osaka-shi (JP); Naoki Matsumoto, Osaka-shi (JP); Shota Ueki, Osaka-shi (JP); Hidenobu Nakanishi, Osaka-shi (JP); Yasuhiro Ueda, Osaka-shi (JP)

(21) Appl. No.: 13/378,057

(22) PCT Filed: Mar. 1, 2010
(86) PCT No.: PCT/JP2010/001377

§ 371 Date: Dec. 14, 2011

(30) Foreign Application Priority Data
Jun. 15, 2009 (JP) 2009-142288

(51) Int. Cl. H01J 9/20; G09G 5/02

(52) U.S. Cl. 445/3; 345/694

(57) ABSTRACT

After source lines have been grouped into a plurality of blocks including adjacent ones of the source lines, in a region outside a display region, at least one inspection bus line for inputting an inspection signal to pixels is formed in association with each of the blocks, and the source lines in each of the blocks are connected to the associated inspection bus line, thereby forming an inspection circuit including the inspection bus lines. Then, an inspection signal is supplied to the pixels from the inspection bus line through the source lines in each of the blocks in the inspection circuit, and a target pixel is compared with a plurality of comparative pixels arranged along one of the source lines along which the target pixel is located, with a gray-level display provided on the display region, thereby detecting a presence of a black point defect in the target pixel.

### TECHNICAL FIELD

The present disclosure relates to methods for inspecting display panels such as liquid-crystal display panels, and methods for fabricating display devices.

### BACKGROUND ART

Recent liquid crystal display devices are thin and lightweight and have relatively low power consumption, and therefore, are widely used in various fields. In particular, the demand for active-matrix liquid crystal display devices has been grown because of high display quality thereof.

An active-matrix liquid crystal display device includes: a thin-film transistor (hereinafter referred to as “TFT”) substrate in which a TFT and a pixel electrode connected to the TFT, for example, are provided in each pixel; a counter substrate facing the TFT substrate; and a liquid-crystal layer sealed between these substrates. The TFT substrate includes gate lines and source lines connected to the TFTs.

With the demand for high-definition display, lines, electrodes, and other components provided in a TFT substrate tend to be miniaturized, causing a problem in which display defects such as point defects easily occur. To avoid such defects, there is a known inspection process of detecting display defects such as point defects before packaging of an external drive circuit and other components in a fabrication process.

In an inspection process, to detect various defects including a light point defect, which is a state of being always in a bright lightening condition, and a black point defect, which is a state of being always in a dark lightening condition, an inspection is performed while displaying a plurality of inspection images on a display panel. In particular, to detect a black point defect, images are displayed in gray levels on the display panel.

Further, in the inspection process, an inspection signal is input to a terminal of each of the gate lines and the source lines drawn to ends of the TFT substrate by bringing an inspection probe into contact with the terminals. At this time, in a known technique, the lines are divided into groups to be connected to inspection bus lines, and an inspection terminal is provided in the inspection bus lines of each of the groups (see, for example, Patent Document 1).

This technique can reduce the number of inspection terminals to be in contact with the inspection probe even with miniaturization of the lines, thereby enabling the inspection probe to easily come into contact with the inspection terminals.

FIG. 14 is a plan view illustrating a conventional liquid-crystal display panel 100 to be inspected. The liquid-crystal display panel 100 includes a display region 101. In a substrate region (hereinafter referred to as a waste substrate region) 102 outside the display region 101, source lines 103 and gate lines 104 are drawn from the display region 101. The source lines 103 are divided into three groups, each of which is connected to six inspection bus lines 105. The inspection bus lines 105 are respectively connected to the source lines 103 in the order of their arrangements. Each of the inspection bus lines 105 has an inspection terminal 106.

On the other hand, the gate lines 104 are divided into two groups, each of which is connected to two inspection bus lines 107. Each of the inspection bus lines 107 has an inspection terminal 108.

In this manner, a so-called source 6-channel inspection circuit is configured. In this circuit, an inspection signal is supplied from the inspection probe to the inspection terminals 106 and 108 to provide a gray-level display on the display region 101, thereby performing an inspection for black point defects.

### CITATION LIST

### Patent Document

PATENT DOCUMENT 1: Japanese Patent Publication No. 2001-356365

### SUMMARY OF THE INVENTION

### Technical Problem

The waste substrate region provided with the inspection bus lines is cut away after an inspection. The waste substrate region is not used in a final product, and thus, is preferably as small as possible, in view of efficient use of a substrate material.

However, since six inspection bus lines are arranged in parallel with each other in the source 6-channel inspection circuit as described above, the waste substrate region has a large area, resulting in the problem of an inefficient use of the substrate material. In addition, as the size of the liquid crystal display device increases, the size of the waste substrate region itself also increases, resulting in that the above problem becomes more serious.

To solve the problem, it is preferable to reduce the area of the waste substrate region by reducing the number of inspection bus lines. However, if the number of, for example, inspection bus lines is reduced in order to reduce an increase in cost for manufacturing apparatus while still using a conventional inspection device such as an inspection probe, a larger number of inspection signals are input to one inspection bus line, resulting that gradient vertical stripes appear on the display region 101 providing a gray-level display, as shown in the photograph of FIG. 12.

FIG. 13 is an enlarged plan view illustrating a black point defect 111 appearing on a gray-level display. As illustrated in FIG. 13, a plurality of pixels 112 are arranged in a matrix on the display region 101. In an inspection for the black point defect 111, the luminance of a target pixel 111 to be inspected is compared with the average luminance of comparative pixels 112a to 112h surrounding the target pixel 111 in eight directions. If the luminance of the target pixel 111 is lower than the average luminance of the comparative pixels 112a to 112h, the target pixel is determined to have a black point defect 111.

However, in a case where gradient vertical stripes appear on the display region 101 as illustrated in FIG. 13, the luminances of the comparative pixels 112a to 112h are not uniform, and decrease (i.e., become dark) toward the right in the drawing. Accordingly, the average luminance of the comparative pixels 112a to 112h decreases, resulting in degradation of the accuracy in detecting a black point defect.

It is therefore an object of the present disclosure to increase the accuracy in detecting a black point defect in a display region providing a gray-level display.

### Solution to the Problem

To achieve the above object, according to the present disclosure, a target pixel to be inspected is compared with a plurality of comparative pixels arranged around the target pixel in directions in which source lines extend with gray levels displayed on a display region.

Specifically, a display-panel inspection method according to the present disclosure is a display-panel inspection method for detecting a presence of a black point defect in a display region including a plurality of parallel source lines and a plurality of pixels arranged in a matrix, and includes the steps of: grouping the source lines into a plurality of blocks including adjacent ones of the source lines, forming, in a region outside the display region, at least one inspection bus line for inputting an inspection signal to the pixels in each of the blocks, and connecting the source lines in each of the blocks to the inspection bus line associated with the block, thereby forming an inspection circuit including the inspection bus lines; and comparing a target pixel with a plurality of comparative pixels arranged along one of the source lines along which the target pixel is located, while providing a gray-level display on the display region by supplying an inspection signal from the inspection bus line to the pixels through the source lines in each of the blocks in the inspection circuit, thereby detecting a presence of a black point defect in the target pixel.

In comparing the target pixel with the comparative pixels, a sum of contrast ratios of the pixels may be calculated based on luminance data on the pixels, and the calculated sum of the contrast ratios may be compared with a predetermined determination threshold value.

In comparing the target pixel with the comparative pixels, a luminance of the target pixel may be compared with an average luminance of the comparative pixels.

In this method, two inspection bus lines may be provided in each of the blocks.

A method for fabricating a display device according to the present disclosure is a method for fabricating a display device including a display region with detection of a presence of a black point defect in the display region including a plurality of parallel source lines and a plurality of pixels arranged in a matrix, and includes the steps of: grouping the source lines into a plurality of blocks including adjacent ones of the source lines, forming, in a region outside the display region, at least one inspection bus line for inputting an inspection signal to the pixels in each of the blocks, and connecting the source lines in each of the blocks to the inspection bus line associated with the block, thereby forming an inspection circuit including the inspection bus lines; and comparing a target pixel with a plurality of comparative pixels arranged along one of the source lines along which the target pixel is located, while providing a gray-level display on the display region by supplying an inspection signal from the inspection bus line to the pixels through the source lines in each of the blocks in the inspection circuit, thereby detecting a presence of a black point defect in the target pixel.

In comparing the target pixel with the comparative pixels, a sum of contrast ratios of the pixels may be calculated based on luminance data on the pixels, and the calculated sum of the contrast ratios may be compared with a predetermined determination threshold value.

In comparing the target pixel with the comparative pixels, a luminance of the target pixel may be compared with an average luminance of the comparative pixels.

In this method, two inspection bus lines may be provided in each of the blocks.

### Advantages

Now, advantages of the present disclosure will be described.

The display region of the display panel includes the parallel source lines and the pixels arranged in a matrix. To detect the presence of a black point defect in this display region, an inspection circuit is formed first.

Specifically, the source lines are grouped into a plurality of blocks, and then in a region outside the display region, at least one inspection bus line is formed in association with each of the blocks. The source lines in each of the blocks are connected to the associated inspection bus line. In this manner, an inspection circuit including the inspection bus lines is formed.

Next, in the inspection circuit, an inspection signal is supplied from the inspection bus line to the pixels through the source lines for each of the blocks of the source lines. In this manner, a gray-level display is provided on the display region.

Then, with the gray-level display provided on the display region, a target pixel is compared with a plurality of pixels (i.e., comparative pixels) arranged along the source line along which the target pixel is located. In this manner, it is determined whether the target pixel has a black point defect or not. This inspection is performed on all the pixels in the display region, thereby detecting the presence of a black point defect in the entire display region.

In a case where vertical stripes extending along the source lines appear in predetermined cycles on the display region where the gray-level display is provided, the display conditions, such as luminances, of the pixels periodically change in the direction intersecting the source lines.

On the other hand, according to the present disclosure, a target pixel is compared to a plurality of comparative pixels arranged along the source line along which the target pixel is located. Accordingly, even when vertical stripes appear on the display region, the display conditions of these comparative pixels can remain substantially constant. As a result, in a case where the target pixel has a black point defect, the display conditions of this target pixel can be distinguished from those of the comparative pixels, thereby enhancing the accuracy in detecting a black point defect in the pixel.

In fabric the display device, the step of forming the inspection circuit and the step of detecting the presence of a black point defect are performed. These steps enable a display device to be fabricated with accurate detection of a black point defect in the display region.

In comparing the target pixel with the comparative pixels, a configuration in which the sum of the contrasts of the pixels is compared with a determination threshold value enables more accurate detection of a pixel having a black point defect. As a result, the accuracy in detecting a black point defect in the display panel can be further enhanced.

### Advantages of the Invention

According to the present disclosure, with a gray-level display provided on a display region, a target pixel is compared with a plurality of comparative pixels arranged along source line along which the target pixel is located, thereby detecting the presence of a black point defect. Accordingly, even when vertical stripes appear on the display region, the display conditions of the comparative pixels can remain substantially constant. As a result, in a case where the target pixel has a black point defect, the display conditions of the target pixel can be distinguished from those of the comparative pixels, thereby enhancing eh accuracy in detecting a black point defect in the target pixel.

### BRIEF DESCRIPTION OF THE DRAWINGS

FIG. 1 is an enlarged plan view illustrating a display region of a liquid-crystal display panel according to a first embodiment.

FIG. 2 is a plan view schematically illustrating a configuration of the liquid-crystal display panel including an inspection circuit according to the first embodiment.

FIG. 3 is a plan view schematically illustrating a black point defect in a display region where vertical stripes appear.

FIG. 4 is a graph showing a relationship between the position in the direction along which gate lines extend on a line IV-IV in FIG. 3 and the luminance of a pixel 15 at each position.

FIG. 5 is a graph showing a relationship between the position in the direction along which source lines extend on a line V-V in FIG. 3 and the luminance of the pixel at each position.

FIG. 6 is a cross-sectional view schematically illustrating a structure of the liquid crystal display device.

FIG. 7 is an enlarged plan view illustrating a side portion of the display region.

FIG. 8 is a flowchart for describing a detect detection method for the liquid-crystal display panel.

FIG. 9 is a table for describing synthesized luminance data.

FIG. 10 is a plan view schematically illustrating a configuration of a liquid-crystal display panel including a source 3-channel inspection circuit according to another embodiment.

FIG. 11 is a plan view schematically illustrating a configuration of a liquid-crystal display panel including a source 1-channel inspection circuit according to still another embodiment.

FIG. 12 is a photograph showing a screen of gray level display including gradient vertical stripes.

FIG. 13 is an enlarged plan view illustrating a black point defect appearing on a gray level display.

FIG. 14 is a plan view illustrating a conventional liquid-crystal display panel to be inspected.

### DESCRIPTION OF EMBODIMENTS

Embodiments of the present disclosure will be described hereinafter with reference to the drawings. The present disclosure is not limited to the following embodiments.

### First Embodiment

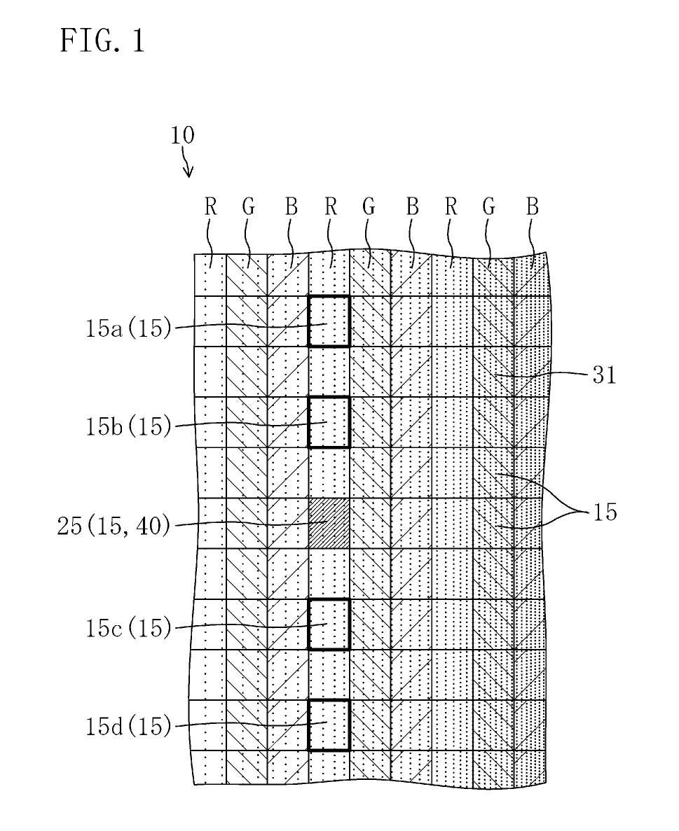

FIGS. 1-7 Illustrate the First Embodiment.

In this embodiment, a liquid crystal display device 1 as an example of a display device will be described.

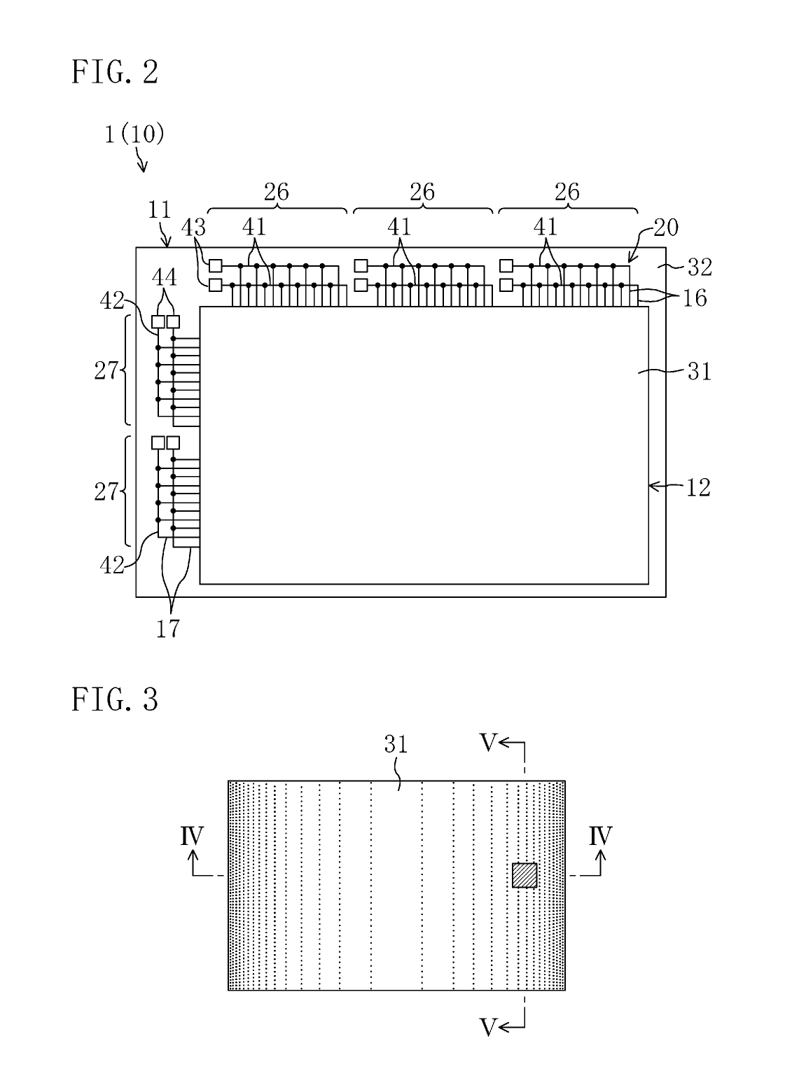

FIG. 1 is an enlarged plan view illustrating a display region of a liquid-crystal display panel 10 according to the first embodiment. FIG. 2 is a plan view schematically illustrating a configuration of the liquid-crystal display panel 10 including an inspection circuit 20 according to the first embodiment. FIG. 3 is a plan view schematically illustrating a black point defect 40 in a display region 31 where vertical stripes appear.

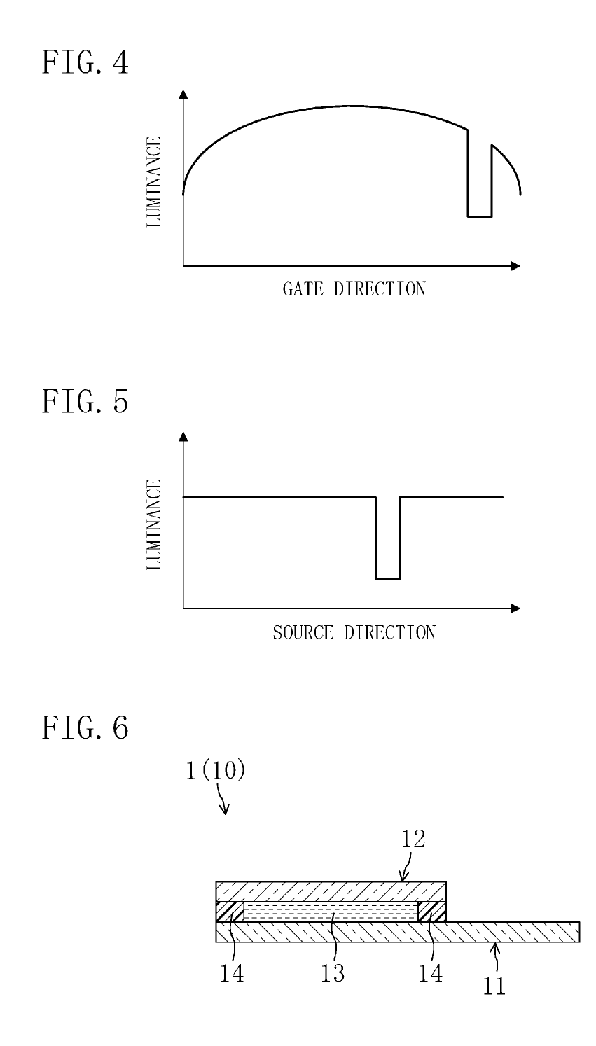

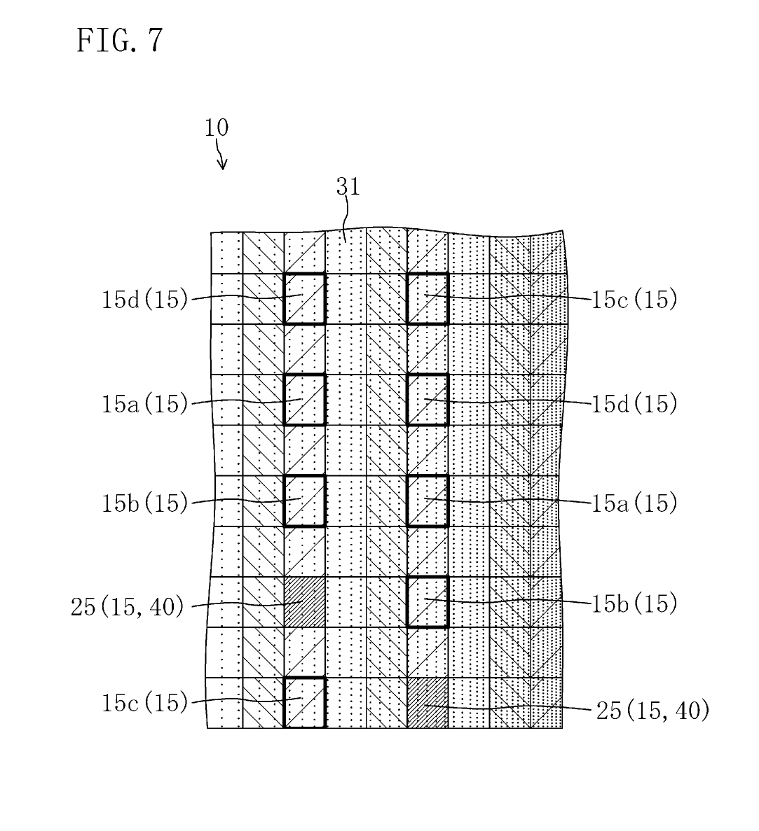

FIG. 4 is a graph showing a relationship between the position in the direction along which gate lines 17 extend on a line IV-IV in FIG. 3 and the luminance of a pixel 15 at each position. FIG. 5 is a graph showing a relationship between the position in the direction along which source lines 16 extend on a line V-V in FIG. 3 and the luminance of the pixel 15 at each position. FIG. 6 is a cross-sectional view schematically illustrating a structure of the liquid crystal display device 1. FIG. 7 is an enlarged plan view illustrating a side portion of the display region 31.

—Configuration of Liquid-Crystal Display Panel—

First, a configuration of the liquid-crystal display panel 10 will be described.

The liquid-crystal display panel 10 forms the liquid crystal display device 1 together with a backlight unit (not shown) located at the back of the liquid-crystal display panel 10 and a casing (not shown) housing these components.

As illustrated in FIG. 6, the liquid-crystal display panel 10 includes: a TFT substrate 11 as an active matrix substrate; a counter substrate 12 facing the TFT substrate 11; and a liquid-crystal layer 13 as a display medium layer sandwiched between the TFT substrate 11 and the counter substrate 12.

The liquid-crystal display panel 10 has a display region 31 and a frame-shaped non-display region surrounding the display region 31. As illustrated in FIG. 1, in the display region 31, a plurality of pixels 15 are arranged in a matrix. The pixel herein is a region (dot) as a minimum unit of a display. Each of the pixels 15 is provided with a colored layer of R (red), G (green), or B (blue). As illustrated in FIG. 1, in the liquid-crystal display panel 10, R, G, and B pixels 15 are arranged in stripes each of which is associated with one of R, G, and B. The stripes of the pixels are repeatedly arranged in the order of R, G, and B.

FIG. 2 illustrates a liquid-crystal display panel 10 before a waste substrate region 32, which will be described later, is separated and removed therefrom. In the following description, the liquid-crystal display panel 10 before the waste substrate region 32 is separated and removed will also be referred to as a liquid-crystal display panel 10.

The counter substrate 12 includes color filters (not shown) and common electrodes (not shown), for example. The liquid-crystal layer 13 is sealed by a sealing member 14 provided between the TFT substrate 11 and the counter substrate 12.

On the other hand, the TFT substrate 11 includes a plurality of parallel source lines 16 and a plurality of gate lines 17 orthogonal to the source lines 16. Specifically, the group of the gate lines 17 and the source lines 16 has a lattice pattern as a whole. The units of the lattice pattern defined by the gate lines 17 and the source lines 16 are provided with the pixels 15. Although not shown, each of the pixels 15 includes a thin-film transistor (TFT) as a switching device, and a pixel electrode connected to the TFT. The TFT is connected to associated ones of the source lines 16 and the gate lines 17.

As illustrated in FIG. 2, before removal of a waste substrate region, the liquid-crystal display panel 10 has a waste substrate region 32 including an inspection circuit 20 and located outside the display region 31. The inspection circuit 20 includes inspection bus lines 41 and 42 for inputting an inspection signal to the pixels 15.

The waste substrate region 32 is formed along two adjacent sides of the liquid-crystal display panel 10. Ends of the source lines 16 are drawn to a portion of the waste substrate region 32 along one side (hereinafter referred to as a source side) of the liquid-crystal display panel 10. On the other hand, ends of the gate lines 17 are drawn to a portion of the waste substrate region 32 along the other side (hereinafter referred to as a gate side) of the liquid-crystal display panel 10.

In fabrication of the liquid-crystal display panel 10, the waste substrate region 32 is separated and removed after a lighting inspection is finished. The above-described non-display region of the liquid-crystal display panel 10 is formed outside the display region 31 after the removal of the waste substrate region 32.

—Configuration of detection circuit—

As illustrated in FIG. 2, in the inspection circuit 20 provided in the source-side portion of the waste substrate region 32, the source lines 16 are grouped into a plurality of blocks 26. Each of the blocks 26 includes adjacent ones of the source lines. The inspection circuit 20 includes at least one first inspection bus line 41 for each of the blocks 26.

In this embodiment, the source lines 16 are grouped into three blocks 26. The blocks 26 are arranged side by side in the direction along which the gate lines 17 are arranged. For each of the blocks 26, two first inspection bus lines 41 intersecting the source lines 16 are disposed side by side in the direction along which the source lines 16 extend. The source lines 16 included in each of the blocks 26 are connected to the first inspection bus lines 41 associated with this block 26.

Among the source lines 16 arranged side by side in the lateral direction in FIG. 2, odd-numbered source lines 16 from the left in the drawing are connected to one of the first inspection bus lines 41, whereas the even-numbered source lines 16 are connected to the other first inspection bus line 41. One end of each of the first inspection bus lines 41 is provided with an inspection terminal 43 to be in contact with an inspection probe. In this manner, the inspection circuit 20 of this embodiment is configured to be a so-called source 2-channel inspection circuit.

On the other hand, in the inspection circuit 20 provided in the gate-side portion of the waste substrate region 32, the gate lines 17 are grouped into two blocks 27, for example, in the same manner as in the source-side portion described above. Two second inspection bus lines 42 are provided for each of the blocks 27. For each of the blocks 27, the odd-numbered gate lines 17 from the top in FIG. 2 are connected to one of the second inspection bus lines 42, whereas the even-numbered gate lines 17 are connected to the other second inspection bus lines 42. One end of each of the second inspection bus lines 42 is provided with an inspection terminal 44 to be in contact with an inspection probe.

—Fabrication Method and Inspection Method—

Now, a method for inspecting the liquid-crystal display panel 10 and a method for fabricating the liquid crystal display device 1 will be described.

A liquid-crystal display panel 10 is fabricated by bonding a TFT substrate 11 including a waste substrate region 32 and a counter substrate 12 with a sealing member 14 and a liquid-crystal layer 13 interposed therebetween. A liquid crystal display device 1 is fabricated by, after an inspection which will be described below, housing the liquid-crystal display panel 10 in which the waste substrate region 32 is separated and removed from the TFT substrate 11 and a backlight unit (not shown) in a casing (not shown).

The inspection method and the fabrication method of this embodiment include a first step of forming an inspection circuit 20 and a second step of providing a gray-level display on the display region 31 to detect the presence of a black point defect 40.

In the first step, in a process of forming a TFT substrate 11, a plurality of source lines 16 are grouped into a plurality of blocks 26, and at least one first inspection bus line 41 is formed for each of the blocks 26 in the waste substrate region 32 located outside the display region 31. In this embodiment, two first inspection bus lines 41 are formed for each of the blocks 26.

Then, the source lines 16 included in each of the blocks 26 are connected to an associated one of the first inspection bus lines 41. Specifically, for example, the odd-numbered source lines 16 from the left in FIG. 2 are connected to the lower first inspection bus line 41 in FIG. 2, whereas the even-numbered source lines 16 are connected to the upper first inspection bus line 41 in FIG. 2.

Further, the inspection terminals 43 are formed at the left ends of the first inspection bus lines 41. The first inspection bus lines 41 and the inspection terminals 43 can be formed at the same time as the source lines 16. In this manner, an inspection circuit 20 is formed in a source-side portion of the waste substrate region 32.

On the other hand, the odd-numbered gate lines 17 arranged from the top in FIG. 2 are connected to the right second inspection bus line 42 in the drawing, whereas the even-numbered gate lines 17 are connected to the left second inspection bus line 42 in the drawing.

Further, inspection terminals 44 are formed at the upper ends of the second inspection bus lines 42. The second inspection bus lines 42 and the inspection terminals 44 can be formed at the same time as the gate lines 17. In this manner, an inspection circuit 20 is formed in a gate-side portion of the waste substrate region 32.

In the second step, in the liquid-crystal display panel 10 having the waste substrate region 32, a gray-level display is provided on the display region 31, thereby detecting a black point defect.

Specifically, in the inspection circuit 20 in the gate-side portion, an inspection probe (not shown) is brought into contact with the inspection terminals 44 to supply signal voltages to all the gate lines 17 through the second inspection bus lines in units of the blocks 27, thereby turning the TFTs of all the pixels on. Further, in the inspection circuit 20 in the source-side portion, an inspection probe (not shown) is brought into contact with the inspection terminals 43 to supply inspection signals from the first inspection bus lines 41 to the pixels 15 through the source lines 16 for each of the blocks 26. In this manner, a gray-level display is provided on the display region 31.

At this time, as shown in FIG. 12, gradient vertical stripes appear on the display region 31 in some cases. The vertical stripes extend along the source lines 16, and show gradation in predetermined cycles along the gate lines 17.

These vertical stripes appear as a result of an increase in the number of inspection signals input to each of the first inspection bus lines 41 in the case of reducing the number of first inspection bus lines 41 while still using a conventional inspection device such as an inspection probe in order to reduce an increase in cost for fabrication apparatus, for example.

In a state in which a gray-level display is provided on the display region 31, the presence of the black point defect 40 is detected by comparing a target pixel 25 with a plurality of comparative pixels 15a to 15d arranged along the source line 16 (i.e., vertically in the drawing) along which the target pixel 25 is located, as illustrated in FIG. 1.

In view of an inspection accuracy and an operation load, it is preferable to provide three comparative pixels which are located each of above and below the target pixel 25, for example. In this embodiment, for convenience of description, two of the comparative pixels 15a to 15d are located each of above and below the target pixel 25. The number of comparative pixels is not specifically limited, and any number of comparative pixels may be provided.

The pixels 15 are compared with one another by capturing an image with a CCD camera (not shown) and performing a computation on this image with a computing means (not shown). In this embodiment, in consideration of resolution of the CCD camera, for example, the pixel 15 at the fourth-pixel position above the target pixel 25 is referred to as a first comparative pixel 15a, and the pixel 15 at the second-pixel position above the target pixel 25 is referred to as a second comparative pixel 15b. Further, the pixel 15 at the second-pixel position below the target pixel 25 is referred to as a third comparative pixel 15c, and the pixel 15 at the fourth-pixel position below the target pixel 25 is referred to as a fourth comparative pixel 15d.

Then, the luminance of the target pixel 25 is compared with the average luminance of the comparative pixels 15a to 15d, thereby determining whether the target pixel 25 has a black point defect 40 or not with the computing means. This detection computation is performed on all the pixels 15 in the display region 31, thereby detecting the presence of the black point defect 40 in the display region 31.

In a case where the target pixel 25 is close to an end of the display region 31 such that the comparative pixels 15c and 15d are expected to be positioned outside the display region 31 as illustrated in FIG. 7, these comparative pixels 15c and 15d are added above the lines including the other comparative pixels 15a and 15b, and detection computation is performed.

Further, in a case where the comparative pixel 15d is positioned off the bottom of the display region 31, for example, the pixel 15 at the second-pixel position above the comparative pixel 15a is added as a comparative pixel 15d. In a case where the comparative pixel 15c is located off the bottom of the display region 31, the pixel 15 at the second-pixel position above the comparative pixel 15d is added as a comparative pixel 15c.

Similarly, in a case where the comparative pixels 15a and 15b are located off the top of the display region 31, these comparative pixels 15a and 15b are added below the other comparative pixels 15c and 15d on the same line, and the detection computation is performed.

Comparison between the target pixel 25 and the comparative pixels 15a to 15d may be conducted by calculating the sum of the contrast ratios of the pixels based on luminance data on the pixels, and comparing the sum of the contrast ratios with a predetermined determination threshold value.

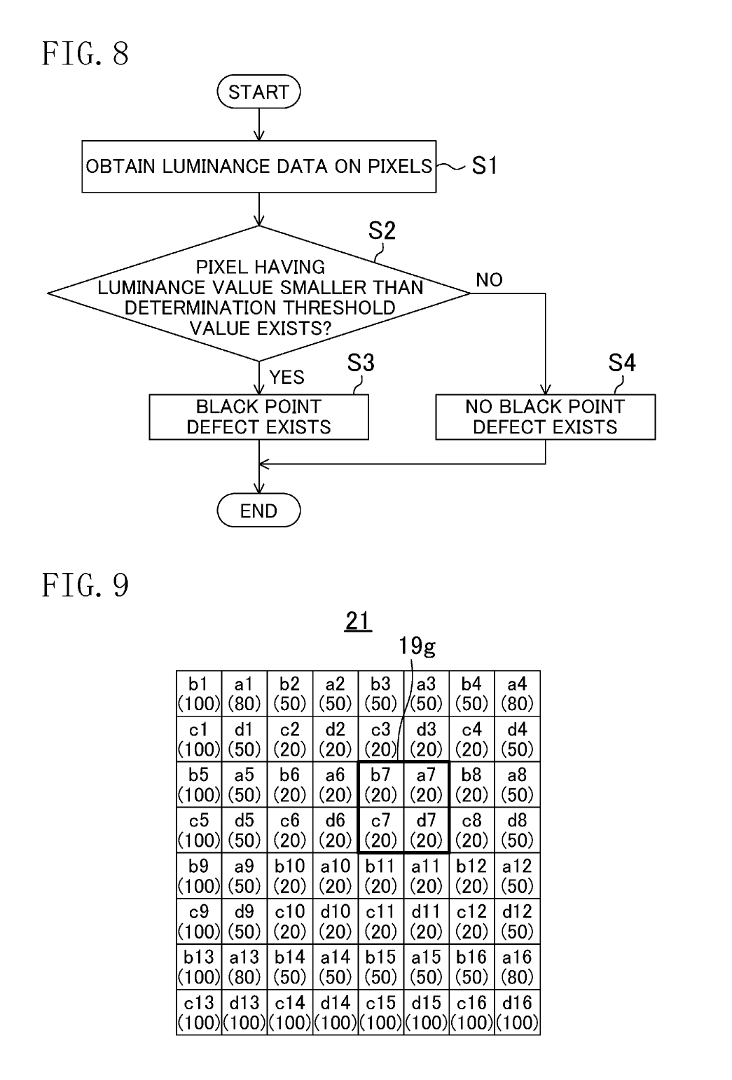

FIG. 8 is a flowchart for describing a detect detection method for the liquid-crystal display panel 10. First, data on an image captured by a CCD camera is processed, thereby obtaining luminance data on the pixels 15 (step S1). Then, based on the luminance data on the pixels 15, it is detected whether a black point defect occurs or not in each of the pixels 15.

Specifically, luminance data on each of the pixels 15 is compared with a predetermined determination threshold value, and based on the comparison result, it is determined whether a black point defect occurs or not in each of the pixels 15. More specifically, it is determined whether a pixel 15 having a luminance value smaller than the predetermined determination threshold value is present or not based on the luminance data on each of the pixels 15 (step S2). If the pixel 15 having a luminance value smaller than the determination threshold value is present, this pixel 15 is determined to have a black point defect 40 (step S3). On the other hand, if a pixel 15 does not have a luminance value smaller than the determination threshold value, this pixel 15 is determined to have no black point defect 40 (step S4).

Now, a method for detecting a black point defect will be described in detail. First, based on luminance data, a difference value between luminances of two adjacent pixels 15 of the same color is calculated, and the obtained difference value is compared with a predetermined determination threshold value. Next, it is determined whether the difference value is larger than the predetermined determination threshold value or not. If the difference value is larger than the determination threshold value, a specific one of the pixels 15 is extracted as a possible pixel having a black point defect 40.

FIG. 9 is a table for describing synthesized luminance data. In FIGS. 9, a1 to a16, b1 to b16, c1 to c16, and d1 to d16 are luminances (received-light luminances) of camera pixels of an image captured by a CCD camera, and these luminances are shown as values within parentheses.

For example, in synthesized luminance data 21 shown in FIG. 9, in a case where target pixels 25 having luminances a7 to d7 in a predetermined camera pixel 19g are blue pixels, a difference value between luminances of these target pixels 25 and comparative pixels forming blue layers is calculated. More specifically, in a case where comparative pixels have a luminance of 100, for example, since the luminances a7 to d7 are 20, the obtained difference value is 80. Then, if the predetermined threshold value is 20, the blue pixels having luminances a7 to d7 are extracted as possible pixels having black point defects.

Subsequently, the same processing is performed on the pixels 15 having luminances a1 to d1, a2 to d2, . . . , and a16 to d16 shown in FIG. 9, thereby extracting possible pixels having black point defects.

Thereafter, the contrast ratios of the pixels 15 extracted as possible pixels having black point defects are calculated. The “contrast ratio” herein is a value obtained by dividing the luminance of each of the pixels 15 extracted as the possible pixels having black point defects by a background luminance.

luminance of pixel extracted as possible pixel having black point defect/background luminance=contrast ratio (1)

The “background luminance” herein is an average luminance of pixels of the same color surrounding a target pixel.

In a case where an image including a black point defect 40 in a target blue pixel is captured by a CCD camera and luminance data on pixels forming a captured-image pixel region surrounding the black point defect 40 is synthesized, for example, since the pixels 15 having luminances a1 to d1, a2 to d2, . . . , and a16 to d16 in the synthesized luminance data 21 shown in FIG. 9 are blue pixels, when a blue pixel is extracted as a possible pixel having a black point defect, contrast ratios of the blue pixels having luminances a1 to d1, a2 to d2, . . . , and a16 to d16 are calculated. For example, in the case of calculating the contrast ratios of pixels 15 (blue pixels) having luminances a7 to d7, each of the luminances a7 to d7 is divided by a background luminance (i.e., 100) of the blue pixels, thereby calculating a contrast ratio (i.e., 20/100=0.2). In the same manner, the contrast ratios of other blue pixels having luminances a1 to d1, a2 to d2, . . . , and a16 to d16 are calculated.

Then, the sum of the obtained contrast ratios (hereinafter referred to as a “sum of detect contrasts” is calculated.

Thereafter, the sum of detect contrasts is corrected according to color information on pixels 15. Specifically, the correction is performed by multiplying the sum of detect contrasts by a correction coefficient according to the sensitivities of red, green, and blue pixels. More specifically, if a sum of detect contrasts of blue pixels having a low sensitivity is obtained, this sum of detect contrasts is tripled, for example. In the case of red pixels, the sum is doubled, and in the case of green pixels, the sum is unchanged (multiplied by one). Specifically, if the obtained sum of detect contrasts of blue pixels is 40, correction is performed by multiplying the sum of detect contrasts (i.e., 40) by a correction coefficient (i.e., 3) according to the sensitivity of blue pixels (i.e., 3×40=120).

Then, the corrected sum of detect contrasts is compared with the predetermined determination threshold value described above, thereby determining whether a pixel 15 having a sum of detect contrasts smaller than or equal to the predetermined determination threshold value is present or not. If the pixel 15 having a sum of detect contrasts smaller than or equal to the predetermined determination threshold value is present, this pixel 15 is determined to have a black point defect 40. On the other hand, if the pixel 15 having a sum of detect contrasts smaller than or equal to the predetermined determination threshold value is not present, this pixel 15 is determined to have no black point defect 40.

For example, if the corrected sum of detect contrasts is 120 and the determination threshold value is 150, it is determined that the pixel 15 having a sum of detect contrasts smaller than or equal to the predetermined determination threshold value is present, and this pixel 15 is determined to have a black point defect 40.

In this manner, in this embodiment, the sum of the contrast ratios of a plurality of pixels 15 is calculated based on luminance data on the pixels 15, and the obtained sum is compared with the determination threshold value.

In this embodiment, even in a case where a blue pixel having a low sensitivity has a black point defect, this black point defect of the blue pixel can be detected without being hidden in the surrounding pixels of green and red having high sensitivities.

Further, in a case where a red pixel or a green pixel has a black point defect 40 and an image including this black point defect 40 is captured by a CCD camera, this black point defect 40 can be detected in the same manner as in the case where a blue pixel has a black point defect 40 described above.

—Advantages of First Embodiment—

In a case where vertical stripes appear as shown in FIG. 3, the luminances of pixels 15 arranged along the gate lines gradually increase or decrease in a region where no black point defects 40 occur as shown in FIG. 4. On the other hand, in this case, the luminances of pixels 15 arranged along the source lines are constant, and do not vary in the region where no black point defects 40 occur as shown in FIG. 5. This is because the vertical stripes extend along the same direction as the source lines 16.

Accordingly, if comparative pixels were locally arranged in the direction along which the gate line 17 extend along which the target pixel 25 is located, the average luminance of the comparative pixels greatly varies depending on the location in the direction along which the gate line extends, as illustrated in FIG. 4. Accordingly, even when the target pixel 25 has a black point defect 40, it is difficult to accurately detect the black point defect 40.

On the other hand, in this embodiment, the direction of arrangement of the comparative pixels 15a to 15d relative to the target pixel 25 coincides with the direction along which the vertical stripes extend. Thus, even when vertical stripes appear on the display region 31, the average luminance of the comparative pixels 15a to 15d can be kept at a constant level.

Accordingly, in a case where the target pixel 25 has a black point defect 40, the luminance of the pixel 25 can be clearly distinguished from the average luminance of the comparative pixels 15a to 15d, thus enhancing the accuracy in detecting the black point defect 40 in the pixel 25. As a result, a liquid crystal display device 1 can be fabricated with highly accurate detection of the black point defect 40 in the display region 31.

### Other Embodiments

In the first embodiment, the inspection circuit 20 has a so-called source 2-channel configuration in which two first inspection bus lines 41 are provided to each of the blocks 26 of the source lines 16. However, the present disclosure is not limited to this configuration.

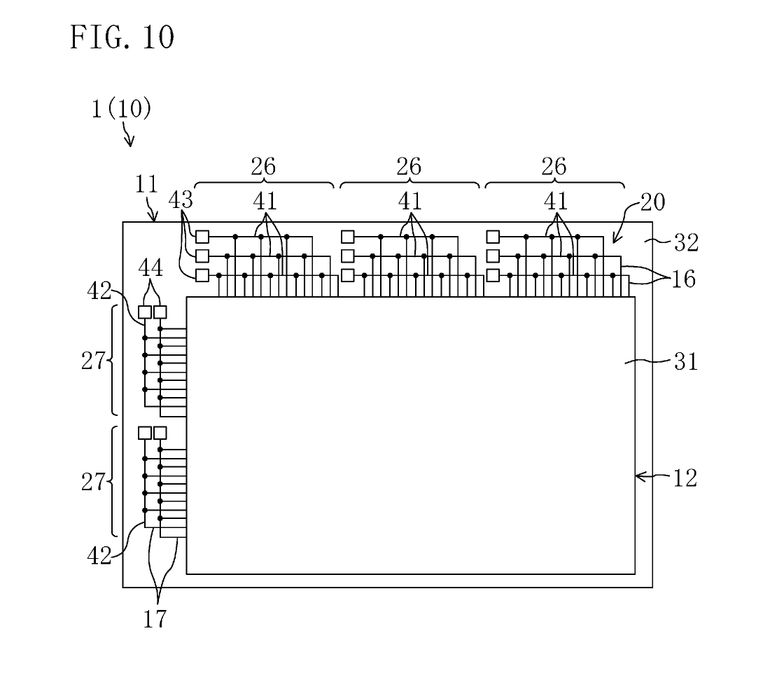

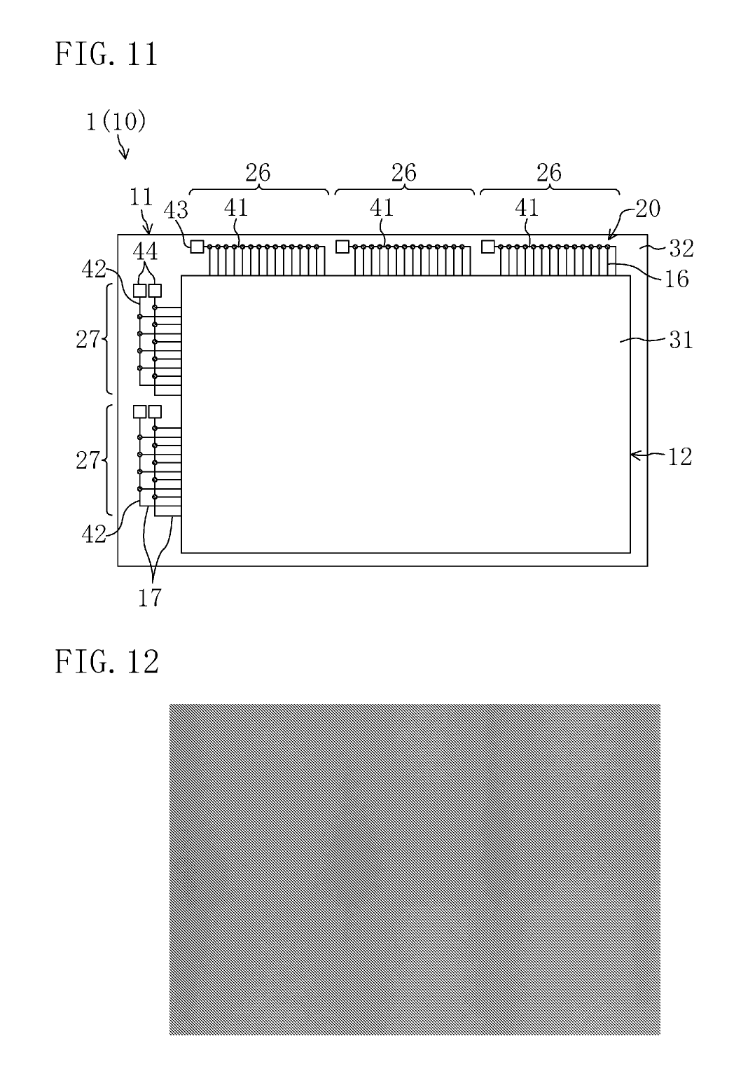

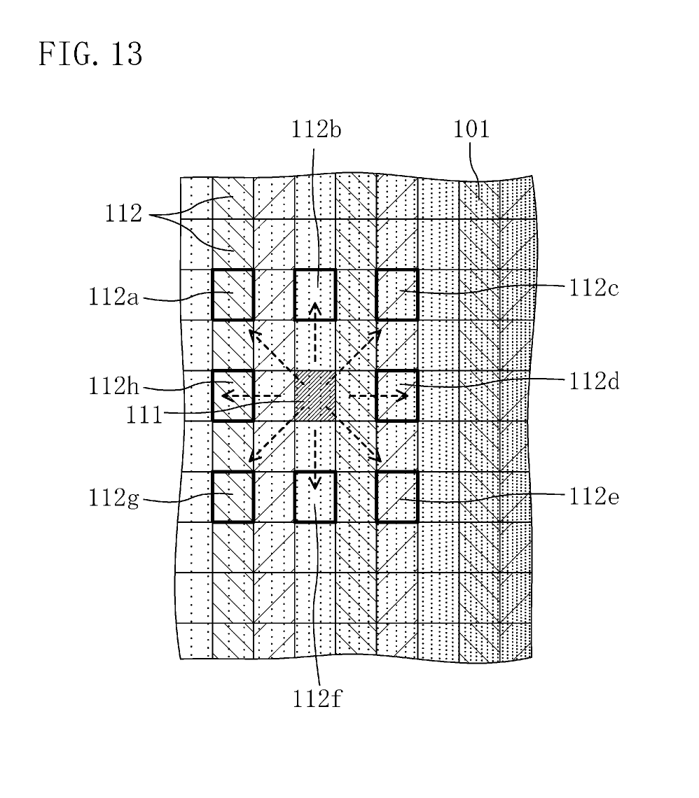

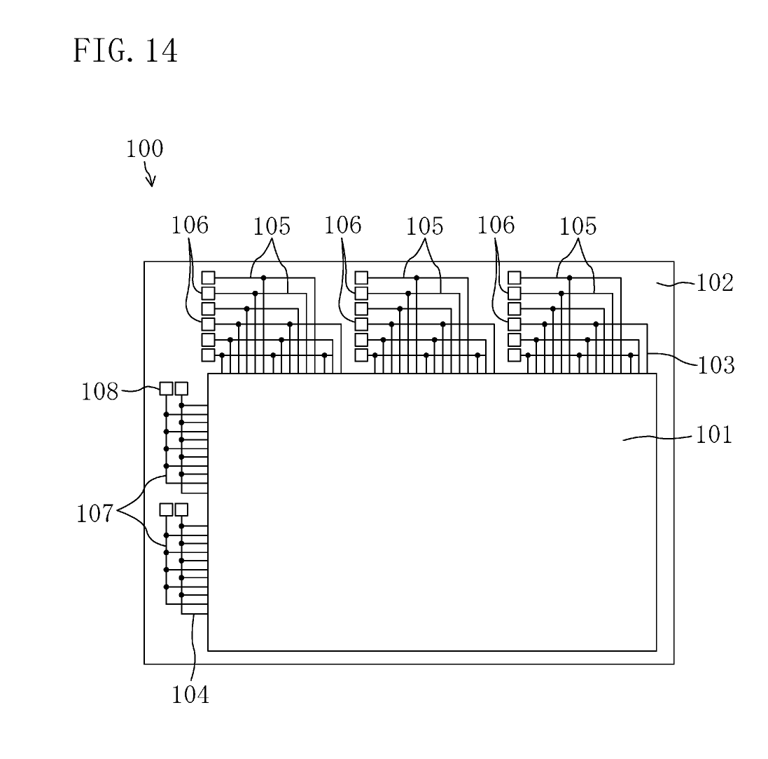

For example, as illustrated in FIGS. 10 and 11, the inspection circuit 20 may have a so-called source 3-channel configuration or a source 1-channel configuration.

FIG. 10 is a plan view schematically illustrating a configuration of a liquid-crystal display panel 10 including a source 3-channel inspection circuit 20 according to another embodiment. FIG. 11 is a plan view schematically illustrating a configuration of a liquid-crystal display panel 10 including a source 1-channel inspection circuit 20 according to still another embodiment.

In a case where the liquid-crystal display panel 10 has a source 3-channel inspection circuit 20, three first inspection bus lines 41 are arranged along the source lines 16 for each of the blocks 26, as illustrated in FIG. 10. The source lines 16 are sequentially connected to the bottom, intermediate, and upper first inspection bus lines 41 in this order from the left in the drawing. In this manner, the source lines 16 connected to the R (red), G (green), or B (blue) pixels are connected to the three first inspection bus lines 41 in such a manner that each of the first inspection bus lines 41 is connected to the source lines 16 associated with one of the colors.

The inspection circuit 20 with this configuration can also detect a black point defect 40 with accuracy while displaying an image in gray levels on the display region 31, as in the first embodiment.

In a case where the liquid-crystal display panel 10 includes a source 1-channel inspection circuit 20, a single first inspection bus line 41 is provided for each of the blocks 26, as illustrated in FIG. 11. The source lines 16 of each of the blocks 26 are connected to the associated first inspection bus line 41. The inspection circuit 20 with this configuration can also detect a black point defect 40 with accuracy while displaying an image in gray levels on the display region 31, as in the first embodiment.

In the first embodiment, the detection method for the liquid-crystal display panel 10 and the method for fabricating the liquid crystal display device 1 are described. However, the present disclosure is not limited to these methods, and is also applicable to other display panels and display devices such as an organic EL display panel (an organic EL display device).

### INDUSTRIAL APPLICABILITY

As described above, the present disclosure is useful for, for example, a method for inspecting a display panel such as a liquid-crystal display panel and a method for fabricating a display device.

### DESCRIPTION OF REFERENCE CHARACTERS

1 liquid crystal display device
10 liquid-crystal display panel
11 TFT substrate
12 counter substrate
13 liquid-crystal layer
14 sealing member
15 pixel
15a to 15d comparative pixels
16 source line
17 gate line
20 inspection circuit
25 target pixel
26 block
31 display region
32 waste substrate region
40 black point defect
41 first inspection bus line

1. A display-panel inspection method for detecting a presence of a black point defect in a display region including a plurality of parallel source lines and a plurality of pixels arranged in a matrix, the method comprising the steps of:
grouping the source lines into a plurality of blocks including adjacent ones of the source lines, forming, in a region outside the display region, at least one inspection bus line for inputting an inspection signal to the pixels in each of the blocks, and connecting the source lines in each of the blocks to the inspection bus line associated with the block, thereby forming an inspection circuit including the inspection bus lines; and
comparing a target pixel with a plurality of comparative pixels arranged along one of the source lines along which the target pixel is located, while providing a gray-level display on the display region by supplying an inspection signal from the inspection bus line to the pixels through the source lines in each of the blocks in the inspection circuit, thereby detecting a presence of a black point defect in the target pixel.

2. The method of claim 1, wherein in comparing the target pixel with the comparative pixels, a sum of contrast ratios of the pixels is calculated based on luminance data on the pixels, and the calculated sum of the contrast ratios is compared with a predetermined determination threshold value.

3. The method of claim 1, wherein in comparing the target pixel with the comparative pixels, a luminance of the target pixel is compared with an average luminance of the comparative pixels.

4. The method of claim 1, wherein two inspection bus lines are provided in each of the blocks.

5. A method for fabricating a display device including a display region with detection of a presence of a black point defect in the display region including a plurality of parallel source lines and a plurality of pixels arranged in a matrix, the method comprising the steps of:
grouping the source lines into a plurality of blocks including adjacent ones of the source lines, forming, in a region outside the display region, at least one inspection bus line for inputting an inspection signal to the pixels in each of the blocks, and connecting the source lines in each of the blocks to the inspection bus line associated with the block, thereby forming an inspection circuit including the inspection bus lines; and
comparing a target pixel with a plurality of comparative pixels arranged along one of the source line along which the target pixel is located, while providing a gray-level display on the display region by supplying an inspection signal from the inspection bus line to the pixels through the source lines in each of the blocks in the inspection circuit, thereby detecting a presence of a black point defect in the target pixel.

6. The method of claim 5, wherein in comparing the target pixel with the comparative pixels, a sum of contrast ratios of the pixels is calculated based on luminance data on the pixels, and the calculated sum of the contrast ratios is compared with a predetermined determination threshold value.

7. The method of claim 5, wherein in comparing the target pixel with the comparative pixels, a luminance of the target pixel is compared with an average luminance of the comparative pixels.

8. The method of claim 5, wherein two inspection bus lines are provided in each of the blocks.
